(19) United States
(12) Patent Application Publication
(10) Pub. No.: US 2025/0139715 A1
(43) Pub. Date: May 1, 2025

(54) METHOD FOR ELECTRICITY MARKET TRANSACTION AND ELECTRIC VEHICLE INCENTIVE USING ELECTRIC VEHICLE CHARGER-LINKED ELECTRIC STORAGE DEVICE, AND RECORDING MEDIUM STORING PROGRAM FOR EXECUTING THE SAME, AND COMPUTER PROGRAM STORED IN RECORDING MEDIUM FOR EXECUTING SAME

(71) Applicant: Hanwha Energy, Sejong-si (KR)

(72) Inventors: Hyewon Shin, Seoul (KR); Heetae Lee, Sejong-si (KR); Yuri Kim, Seoul (KR); Kyungmin Jin, Yongin-si (KR)

(73) Assignee: Hanwha Energy, Sejong-si (KR)

(21) Appl. No.: 18/399,090

(22) Filed: Dec. 28, 2023

(30) Foreign Application Priority Data
Oct. 31, 2023 (KR) 10-2023-0147414

(51) Int. Cl. G06Q 50/06; B60L 53/62; B60L 53/63; G06Q 40/04; H02J 7/00

(52) U.S. Cl. CPC G06Q 50/06; B60L 53/62; B60L 53/63; G06Q 40/04; H02J 7/0013

(57) ABSTRACT

Proposed is a method for electricity market transactions and electric vehicle incentives using an electric vehicle charger-linked electric storage device, a recording medium storing a program for executing the method, and a computer program stored in a recording medium to execute the method. In more detail, proposed are: a method for electricity market transactions and electric vehicle incentives using an electric vehicle charger-linked electric storage device, the method being designed to maximize the profit of a Charge Point Operator (CPO) on the basis of participation in a demand management market (electricity market) of an energy storage system (ESS) linked to an electric vehicle charging system and of charging/discharging arbitrage of an ESS; a recording medium storing a program for executing the method; and a computer program stored in a recording medium to execute the method.

### CROSS REFERENCE TO RELATED APPLICATION

The present application claims priority to Korean Patent Applications No. 10-2023-0147414, filed Oct. 31, 2023, the entire contents of which are incorporated herein for all purposes by this reference.

### BACKGROUND

### Technical Field

The present disclosure relates to a method for electricity market transactions and electric vehicle incentives using an electric vehicle charger-linked electric storage device, a recording medium storing a program for executing the method, and a computer program stored in a recording medium to execute the method. In more detail, the present disclosure relates to: a method for electricity market transactions and electric vehicle incentives using an electric vehicle charger-linked electric storage device, the method being designed to maximize the profit of a Charge Point Operator (CPO) on the basis of participation in a demand management market (electricity market) of an energy storage system (ESS) linked to an electric vehicle charging system and of charging/discharging arbitrage of an ESS; a recording medium storing a program for executing the method; and a computer program stored in a recording medium to execute the method.

### Description of the Related Art

In terms of demand, policies for promoting construction of traffic systems and purchases are being actively carried out all over the world with the popularization of electric vehicles, and the demand for electric vehicles is rapidly increasing as a part of restrictions on discharge of exhaust gas and eco-friendly policies for internal combustion engine vehicles in global variations including Korea.

A reference scenario by the International Energy Agency (IEA) forecasted that 6 million electric vehicles will be supplied in 2030, but it is forecasted that over 20 million electric vehicles will be supplied by efforts by policy in leading electrical vehicle producing countries, such as developed countries and China.

An increase of electric vehicles can be considered as an increase of energy resources, and the density of energy that is used is also increased with technical development.

In terms of supply, an increase of renewable energy such as the light of the sun, the power of wind, etc. cause problems in terms of intermittence and flexibility, and in order to solve these problems, various market rules such as establishment of a plus DR market for a load increase are being introduced.

In particular, when the amount of electricity generation is larger than the amount of consumption, it is possible to maintain system stability through curtailment of renewable energy such as sunlight, but enabling the amount of electricity generation of pure energy to be continued and operating a system using more clean energy are problems that the whole world faces.

However, in relation to an increase of demands of electrical vehicles, it is possible to use stored energy only when inducing electric vehicles that are being driven or are parked to a charging station, so an accumulation technique is an important key technology in use of energy.

Accordingly, there is a need for a technology of inducing the vehicles of customers to a charger and it is required to construct an environment in order to be able to control vehicles in linkage with an appropriate IT technology.

A DR market exists to solve problems by reducing demands due to an increase or a shortage of intermittent and short-time electricity generation resources. DR for solving the problem of reduction of a load, which is minus DR, is made through transactions in a plus DR market in which demands are increased and can be flexibly controlled through an ESS and an electric vehicle, so it is possible to participate in a market.

A charge point operator may solve the problem with additional electricity consumption requirements awarded in a plus DR market not to limit electricity generation from renewable energy, but there is a problem that there is high possibility that electric vehicles may not be charged timely by a desired amount through solution with large useful variation, depending on the owner's intention and the environment.

It is possible to partially solve this problem through various methods using behavior induction, that is, incentive elements such as issuing coupons, providing local money, and reducing a charge rate, but there is unavoidably a limit.

An electric vehicle charger applied fast demand response in an ancillary service of an electric power system, and a method and apparatus for controlling a charging poser of the electric vehicle charger have been disclosed in Korean Patent No. 10-2150044.

### RELATED ART DOCUMENTS

### Patent Documents

(Patent Document 1) Korean Patent No. 10-2150044 (registration date: 2020.08.25)

### SUMMARY

Accordingly, the present disclosure has been made in an effort to solve the problems described above and an objective of the present disclosure is to provide: a method for electricity market transactions and electric vehicle incentives using an electric vehicle charger-linked electric storage device, the method being designed to maximize the profit of a Charge Point Operator (CPO) on the basis of participation in a demand management market (electricity market) of an energy storage system (ESS) linked to an electric vehicle charging system and of charging/discharging arbitrage of an ESS; a recording medium storing a program for executing the method; and a computer program stored in a recording medium to execute the method.

The objectives of the present disclosure are not limited to those described above and other objects not stated herein would be apparently understood by those who have ordinary skills in the art that the present disclosure belongs to from the following description.

An embodiment of the present disclosure provides a method for electricity market transactions and electric vehicle incentives using an electric vehicle charger-linked electric storage device, the method being implemented in a program type that is executed by a computing device including a computer and using an energy storage system (ESS) linked to an electric vehicle charging system, the method including: a demand response market participation step in which the computing device progresses operation of charging and discharging the ESS by establishing a strategy related to the number of electric vehicles to induce and a plan for charging and discharging the ESS in each hour in accordance with a DR (demand response) market participation time when the ESS participates in an electricity demand management market (electricity market); an ESS charging step in which the computing device charges the ESS in preset light load hours when the ESS does not participate in the electricity demand management market (electricity market); a system standby step in which the computing device stands by until a predetermined discharging time when the ESS finishes being charged; and an ESS discharging step in which the computing device establishes a discharging plan to completely discharge energy stored in the ESS during the discharging time, establishes a promotion operation plan, and progresses the promotion in accordance with the promotion operation plan.

The plan for charging and discharging the ESS in the demand response market participation step may determine the number of electric vehicle to strategically collect in a day when participating in the DR market in the side of a charge point operator and establish an operation strategy on the basis of the number.

The plan for charging/discharging the ESS in the demand response market participation step may satisfy conditions of an objective function,

$$Max . {Cost}_{total} = {Cost}_{DR} + {Cost}_{Arbitrage}$$

a constraint function,

$${Cost}_{DR} = {\sum }_{t = 1}^{24} ( ( {E}_{EV} ( t ) + {E}_{ESS} ( t ) ) \times {Cost}_{DR} ( t ) ) - {Cost}_{Penalty} \\ {Cost}_{Arbitrage} = {\sum }_{t = 1}^{24} ( {E}_{ESS} ( t ) \times {Cost}_{Time} ( t ) ) \\ 0 \leq {E}_{E} ( t ) + {E}_{ESS} ( t ) \leq Min ( {P}_{Contract} , {P}_{Target} ) \\ If . {E}_{target} ( t ) > ( {E}_{EV} ( t ) + {E}_{ESS} ( t ) ) \\ {Cost}_{Penalty} = {\sum }_{t = 1}^{24} ( ( {E}_{target} ( t ) - ( {E}_{EV} ( t ) - {E}_{ESS} ( t ) ) \times {Cost}_{DR} ( t ) ) \times {Weight}_{Penalty}$$

(where Max. Costₜₒₜₐₗ is a maximum profit (won) using an ESS, Cost_{DR} is a profit (won) through participation in a DR market, Cost_{Arbitrage} is a profit (won) through arbitrage of an electricity rate, Cost_{Penalty} is a penalty cost (won) due to shortage of DR dynamic response, E_{EV} (t) is a charged amount (kWh) of electric vehicles in each hour, E_{ESS} (t) is charged (+)/discharged (−) amount (kWh) of an ESS in each hour, Cost_{DR}(t) is the amount of awarded price (won/kWh) in a DR market in each hour, Cost_{Time} (t) is an electricity rate (won/kWh) of an EV charging station in each hour, P_{Contract} is a contracted capacity of an EV charging station, P_{Target} is a target peak capacity of an EV charging station, and Weight_{Penalty} is a DR penalty cost weight (p.u)).

The objective function of the plan for charging/discharging the ESS may calculate profits from a profit that is gained by participating in a plus/general DR market and an arbitrage profit that is generated by supplying electricity, which is stored in light load hours through the ESS, in medium load/maximum load hours to maximize a total profit that is obtained through participation in the DR market using the ESS and electric vehicles and electricity rate arbitrage using the ESS.

In the constraint function of a plan for charging/discharging an ESS, a target number of electric vehicles to be charged and a target charging amount should be values considering charging times of rapid/slow chargers, a total number of electric vehicles that are charged per hour should not exceed the number of chargers, charging amounts of electric vehicles and the amount of energy for charging and discharging of the ESS in each hour should be larger than 0 and should be lower than electricity of an electric vehicle charging station and target maximum power consumption, and when a penalty cost is generated due to dynamic response not reaching an awarded amount of the DR market, the cost may be additionally applied.

The promotion operation plan of the ESS discharging step may be to set a stage for each hour, set intensity of the promotion in each stage, set a price for providing the promotion, and establish a promotion strategy on the basis of the stage, the intensity, and the price.

The promotion operation plan of the ESS discharging step may be to set hours pertaining to a preset maximum load in a period of 09:00˜12:00 as first stage hours, set hours pertaining to a preset maximum load in a period of 13:00˜19:00 as second stage hours, set hours pertaining to a preset medium load after the second stage hours as third stage hours, establish the promotion operation plan with relatively low intensity for the first stage hours, and establish the promotion operation plan with relatively high intensity for the second stage hours and the third step hours.

A price for providing a promotion included in the promotion operation plan of the ESS discharging step may be calculated from the following equation,

$${Cost}_{PR} ( t ) = ( {Cost}_{kWh} ( t ) - {Cost}_{CHA} ) \times {Ratio}_{B 2 B} \times {Ratio}_{B 2 C} \times {E}_{CHA} ( t )$$

(where Cost_{kwh}(t) is the price (won) for providing a promotion in a corresponding hour, Cost_{CHA} is an electricity rate (won/kWh) under KEPCO in a corresponding hour, Ratio_{B2B} is an electricity rate (won/kWh) used for charging an ESS under KEPCO, Ratio_{B2C} is a profit distribution ratio (p.u) between a demand manager and a CPO, E_{CHA} (+) is a profit distribution ratio (p.u) between a COP and an owner of an electric vehicle including an incentive, and Cost_{kwh} (t) is the amount of electricity (kWh) used to charge electric vehicles in a corresponding hour).

An embodiment of the present disclosure provides a computer-readable recording medium storing a program for implementing the method for electricity market transactions and electric vehicle incentives using an electric vehicle charger-linked electric storage device.

An embodiment of the present disclosure provides a program stored in a computer-readable recording medium for implementing the method for electricity market transactions and electric vehicle incentives using an electric vehicle charger-linked electric storage device.

According to the method for electricity market transactions and electric vehicle incentives using an electric vehicle charger-linked electric storage device, a recording medium storing a program for executing the method, and a computer program stored in a recording medium to execute the method, there is an effect of increasing the profit of a Charge Point Operator (CPO) on the basis of participation in a demand management market (electricity market) of an energy storage system (ESS) linked to an electric vehicle charging system and of charging/discharging arbitrage of an ESS.

Further, there is an effect that it is possible to gain additional profits by participating in a market by using or storing electrical energy when an ESS liked to an electric vehicle charging system is required as a plus DR or minus DR resource in an electricity market.

Further, there is an effect that it is possible to gain additional profits using the energy of an ESS when charging electric vehicles together with a corresponding operation plan and it is possible to use an ESS as a resource that can secure reliability of a power system through a sector coupling effect.

Further, there is an effect that customer can save costs for charging an electric vehicle through a promotion and a CPO can attract customers.

Further, there is an effect that it is possible to expand business by inducing competition of CPOs because it is possible to induce customers through strategic cooperation of CPOs.

### BRIEF DESCRIPTION OF THE DRAWINGS

FIG. 1 is a flowchart of a method for electricity market transactions and electric vehicle incentives using an electric vehicle charger-linked electric storage device according to an embodiment of the present disclosure;

FIG. 2 is a conceptual diagram showing an example of a system to which the method for electricity market transactions and electric vehicle incentives using an electric vehicle charger-linked electric storage device according to an embodiment of the present disclosure can be applied;

FIG. 3 is an exemplary diagram showing rates that a charge point operator receives from customers and costs that the charge point operator pays to a power company;

FIG. 4 is an exemplary diagram numerically showing the configuration of medium load and maximum load hours in each month of an electric vehicle charge rate plan;

FIG. 5 is an exemplary diagram numerically showing the configuration of the profits that a charge point operator can gain on the basis of electricity consumption rate and electric vehicle charge costs;

FIG. 6 is an exemplary diagram numerically showing the configuration of a gain in terms of charging of electric vehicles and a gain in terms of an energy storage system (ESS);

FIG. 7 is an exemplary diagram numerically showing the configuration of gains that a charge point operator (CPO) can obtain in respective load hours in accordance with the rates that the COP receives;

FIG. 8 is an exemplary diagram numerically showing the configuration of gains that a CPO can obtain in accordance with profit percentages;

FIG. 9 is an exemplary diagram numerically showing the configuration for a charging/discharging plan for maximizing gains that can be obtained in accordance with the method for electricity market transactions and electric vehicle incentives using an electric vehicle charger-linked electric storage device; and

FIG. 10 is a system block diagram of a computing device.

### DETAILED DESCRIPTION

The present disclosure may be modified in various ways and implemented by various exemplary embodiments, so that specific exemplary embodiments are shown in the drawings and will be described in detail. However, it should be understood that the present disclosure is not limited to the specific exemplary embodiments, but includes all modifications, equivalents, and substitutions included in the spirit and the scope of the present disclosure.

It is to be understood that when one element is referred to as being “connected to” or “coupled to” another element, it may be connected directly to or coupled directly to another element or be connected to or coupled to another element with the other element therebetween.

On the other hand, it should be understood that when one element is referred to as being “connected directly to” or “coupled directly to” another element, it may be connected to or coupled to another element without the other element therebetween.

Terms used in the present disclosure are used only in order to describe specific exemplary embodiments rather than limiting the present disclosure. Singular forms are intended to include plural forms unless the context clearly indicates otherwise. It will be further understood that the terms “comprise” or “have” used in this specification, specify the presence of stated features, steps, operations, components, parts, or a combination thereof, but do not preclude the presence or addition of one or more other features, numerals, steps, operations, components, parts, or a combination thereof.

Unless otherwise defined, all terms including technical and scientific terms used herein have the same meanings as commonly understood by those skilled in the art to which the present disclosure belongs. It must be understood that the terms defined by the dictionary are identical with the meanings within the context of the related art, and they should not be ideally or excessively formally defined unless the context clearly dictates otherwise.

Hereafter, the present disclosure is described in detail with reference to the accompanying drawings. The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the invention. Further, unless stated otherwise, the technical terms and scientific terms used herein have meanings that those skilled in the art generally understand, and well-known functions and configurations that may make the main idea of the present disclosure unclear in the following description and the drawings are not described in detail. Embodiments to be described hereafter are provided as examples for sufficiently communicating the spirit of the present disclosure to those skilled in the art. Accordingly, the present disclosure is not limited to the proposed drawings and may be implemented by other ways. Like reference numerals indicate the same components throughout the specification. It should be understood that like components are given like reference numerals throughout the drawings.

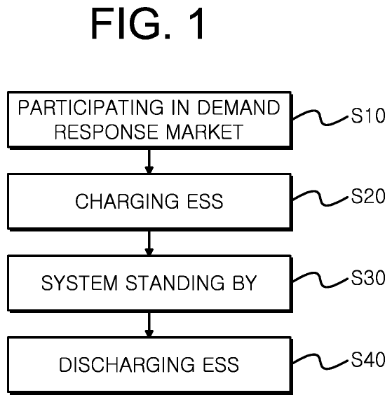

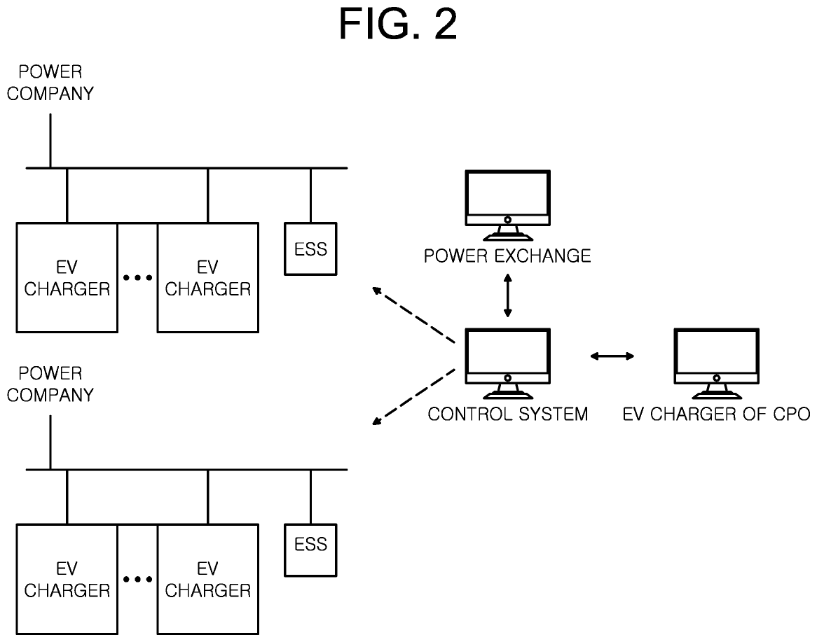

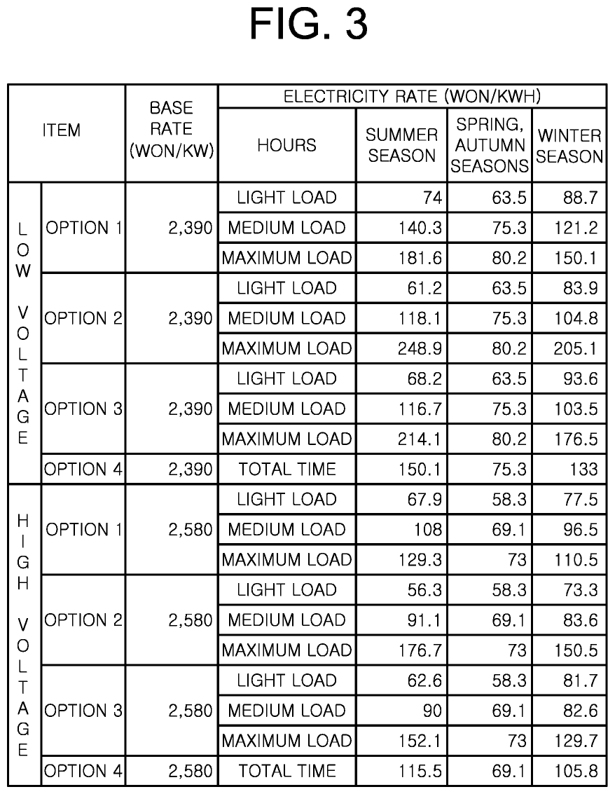

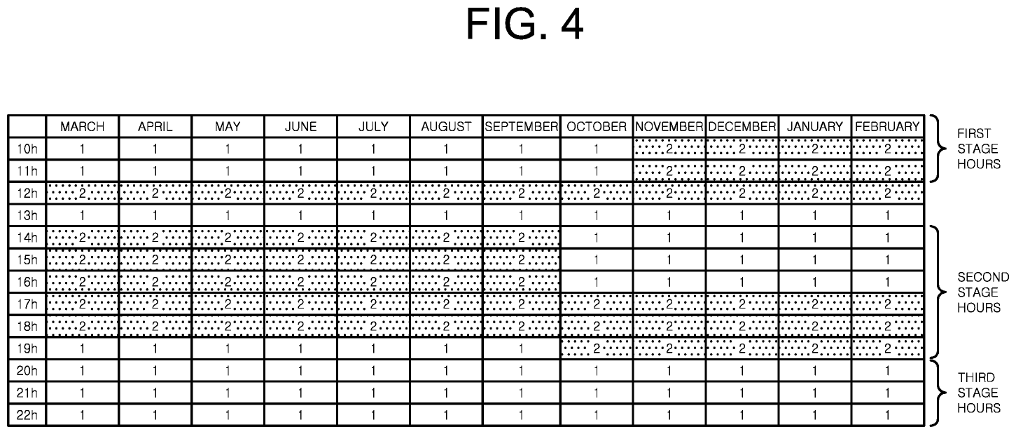

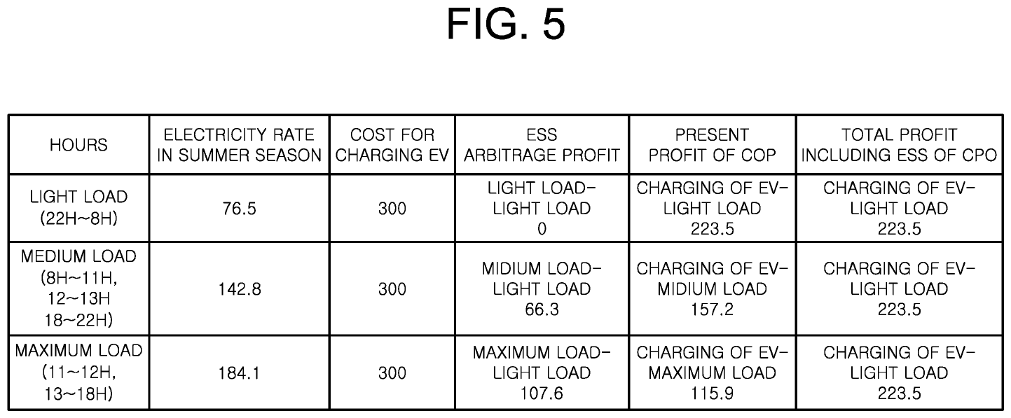

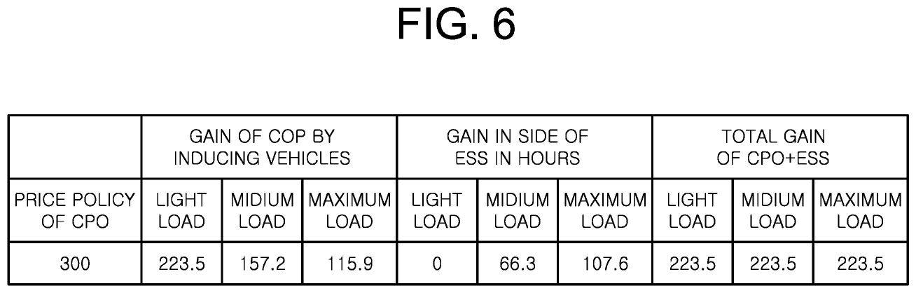

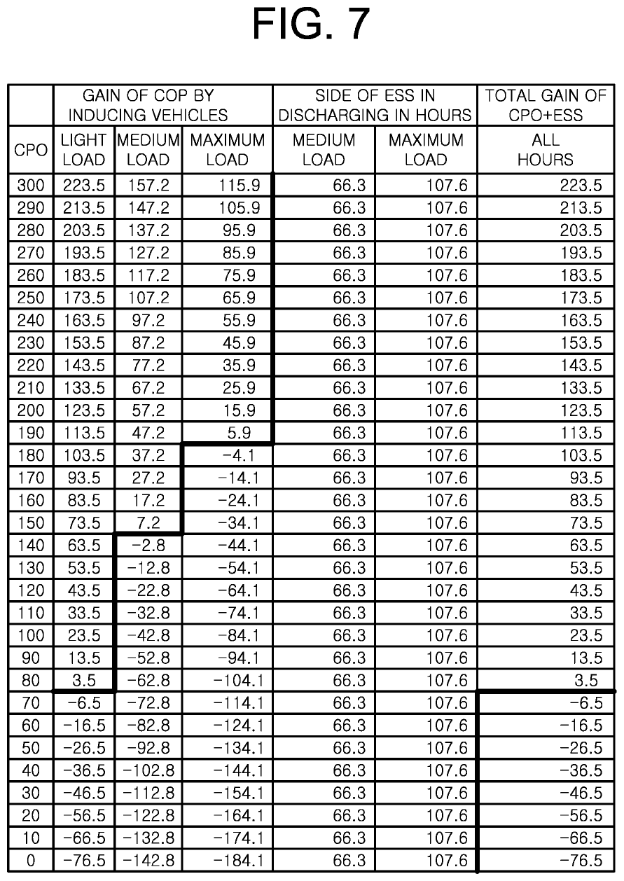

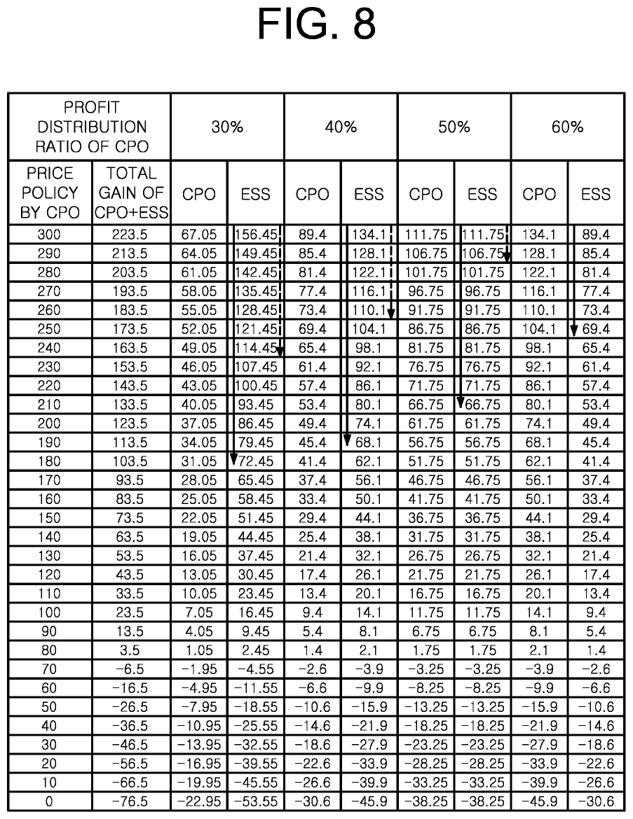

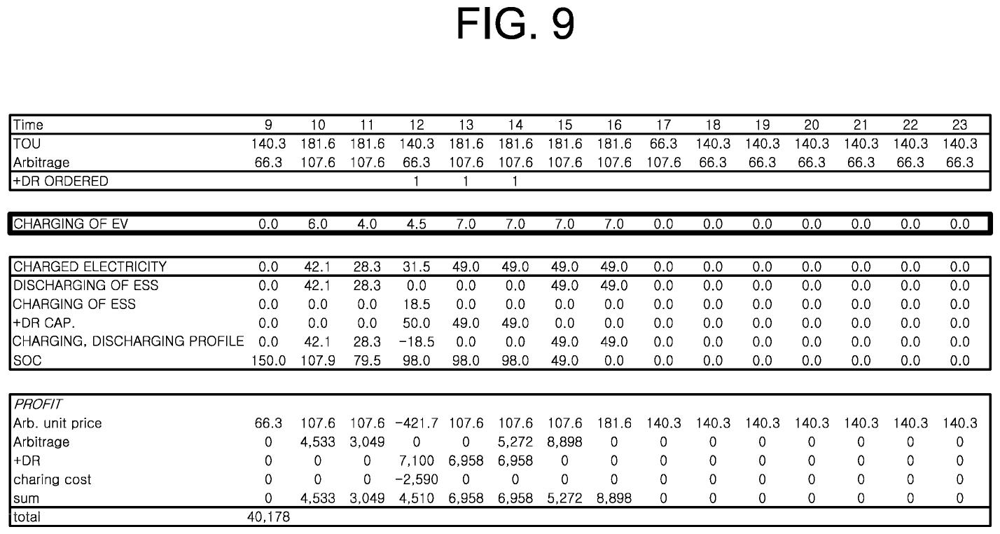

FIG. 1 is a flowchart of a method for electricity market transactions and electric vehicle incentives using an electric vehicle charger-linked electric storage device according to an embodiment of the present disclosure, FIG. 2 is a conceptual diagram showing an example of a system to which the method for electricity market transactions and electric vehicle incentives using an electric vehicle charger-linked electric storage device according to an embodiment of the present disclosure can be applied, FIG. 3 is an exemplary diagram showing rates that a charge point operator receives from customers and costs that the charge point operator pays to a power company, FIG. 4 is an exemplary diagram numerically showing the configuration of medium load and maximum load hours in each month of an electric vehicle charge rate plan, FIG. 5 is an exemplary diagram numerically showing the configuration of the profits that a charge point operator can gain on the basis of an electricity consumption rate and electric vehicle charge costs, FIG. 6 is an exemplary diagram numerically showing the configuration of a gain in terms of charging of electric vehicles and a gain in terms of an energy storage system (ESS), FIG. 7 is an exemplary diagram numerically showing the configuration of gains that a charge point operator (CPO) can obtain in respective load hours in accordance with the rates that the COP receives, FIG. 8 is an exemplary diagram numerically showing the configuration of gains that a CPO can obtain in accordance with profit percentages, and FIG. 9 is an exemplary diagram numerically showing the configuration for a charging/discharging plan for maximizing gains that can be obtained in accordance with the method for electricity market transactions and electric vehicle incentives using an electric vehicle charger-linked electric storage device.

A method for electricity market transactions and electric vehicle incentives using an electric vehicle charger-linked electric storage device according to an embodiment of the present disclosure provides a method of progressing a promotion on the basis of an energy storage system (ESS) operation plan for maximizing the profits of a charge point operator on the basis of participation in a demand response (DR) market of the ESS linked to an electric vehicle charging system and charging/discharging arbitrage of the ESS.

As shown in FIG. 1, the method for electricity market transactions and electric vehicle incentives using an electric vehicle charger-linked electric storage device is implemented in a program type that is performed by a computing device including a computer. The method for electricity market transactions and electric vehicle incentives using an electric vehicle charger-linked electric storage device for operation profits of electric vehicle chargers and market transactions of a power system using an electric vehicle charging system-liked ESS includes a demand response market participation step (S10), an ESS charging step (S20), a system standby step (S30), and an ESS discharging step (S40).

The method for electricity market transactions and electric vehicle incentives using an electric vehicle charger-linked electric storage device according to an embodiment of the present disclosure has been designed for operation profits of electric vehicle chargers and transactions of a power system using an electric vehicle charging system-liked ESS.

As shown in FIG. 2, each electric vehicle charging station includes electric vehicle chargers and an ESS.

The electric vehicle chargers installed at each electric vehicle charging station can be monitored through the control system of a Charge Point Operator (CPO).

An aggregator system may exchange data in linkage with the control system of a CPO and may be linked with a power exchange for demand resource transactions.

Further, an ESS may be configured as one system in an electric vehicle charging station and may be constructed through a parallel configuration on an AC low voltage line.

An aggregation system is mounted with an algorithm for operating distributed ESSs and can perform a function of inducing electric vehicles and establishing a strategy for a promotion of a CPO.

An aggregation system may have an electricity transaction function including a demand response (DR) market participation with a power exchange, can be provided with price information for day-ahead market, intra-day market, and real-time market linkage, and, depending on the result, can transmit an operation schedule of ESSs and an electric vehicle charging station operation strategy to a CPO.

As shown in FIG. 3, an electricity consumption rate, which is a rate that a COP is supposed to pay to a power company, is configured in various ways, depending on the voltages and selective rates that are provided by an electric vehicle charging service provider under Article 12 and Article 8 of Enforcement Decree of Act on the creation and facilitation of use of smart grids of Korea.

In the demand response market participation step (S10), when the ESS participates in an electricity demand management market (electricity market) and an awarded amount for participation in a Demand Response (DR) market is determined, the computing device, in order to maximize profits through the ESS, establishes a strategy about the number of vehicles to induce in hours in accordance with DR market participation times and a plan for charging/discharging the ESS and determines whether to operate the ESS in accordance with the electricity purchase prices in corresponding hours of DR market participation and power consumption by electric vehicles, thereby progressing a charging/discharging operation of the ESS.

In general, it is difficult to expect when vehicles come and how many vehicles are charged at public electricity charging stations and it is required to accurately consume/reduce an awarded amount when participating in a plus/minus DR market, so it is possible to improve reliability using power storage devices such as an ESS and such improvement of reliability of participation in a DR market can contribute to stability of an electric system.

DR is classified into plus DR that increases demands and minus DR that decreases demands and it is possible to participate in them through an ESS and an electric vehicle charger.

In the ESS charging step (S20), when the ESS does not participate in an electricity demand management market (electricity market), the computing device charges the ESS in a preset light load hours (ex, from 23:00 to 09:00 in the next morning) on the basis of electricity rates, but when an electric vehicle is being charged, the computing device charges the ESS while controlling the charging amount such that the sum of the total amount of in-charging electricity and the charging capacity of the ESS is maintained at contracted electricity of at a set value under the contracted electricity.

In the case of not participating in a demand management market within a predetermined period (one day before/the day, etc.), the computing device charges the ESS in the light load hours (from 23:00 to 09:00 in the next morning) with the lowest electricity rate.

The predetermined time may be a period for which it is possible to fully charge the ESS through charging for the light load hours (from 23:00 to 09:00 in the next morning).

Further, since all electric vehicle charging stations are not supposed to use electricity over a contracted capacity, when an electric vehicle is being charged, charging should be performed such that the sum of the total amount of in-charging electricity and the charging capacity of the ESS is maintained at contracted electricity or a set value under the contracted electricity.

In the system standby step (S30), when the ESS finishes being charged, the computing device stops charging/discharging the ESS and stands by until a predetermined discharging time.

That is, when the ESS finishes being charged, the computing device stands by until the time at which next discharging is required.

The time at which discharging is required (discharging time), generally, may be maximum load hours, and when electricity is not completely consumed in the maximum load hours, medium load hours may also be included in the discharging time so that remaining energy can be consumed.

In other words, the electricity stored in the ESS is not used until a required hour after complete charging even though an electric vehicle performs charging.

In the ESS discharging step (S40), the computing device controls the ESS to charge electric vehicles for the discharging time, establishes a discharging plan and a promotion operation plan such that the energy stored in the ESS is fully discharged for the discharging time, and when there is a difference between the number of electric vehicles expected in the discharging plan and the actual number of electric vehicles charged at the charging station, the computing device changes and updates the discharging plan and the promotion operation plan and progresses a promotion in accordance with the promotion operation plan.

When bidding for DR is not progressed, electricity is charged in the ESS in the light load rate hours in each season, so arbitrage is possible in the case of supplying energy to electric vehicles combing to charge in the medium load or maximum load hours, whereby it is possible to gain additional profits.

The purpose of the promotion is a strategy for maximizing profits by completely consuming remaining energy when there is remaining energy in the ESS.

That is, when demands of electric vehicles are less than a plan, it is possible to maximize profits through a promotion method for inducing electric vehicles.

It is possible to continuously roll, update, and re-plan a promotion plan in predetermined hours on the day after a D-1 plan.

This process is performed when there is a difference between the expected number of vehicles to be charged and the number of vehicles actually coming to charge, and in order to complement the difference between the plan and the reality, there are various methods of inducing customers such as by progression a promotion and providing additional incentives to electric vehicle customers participating in the promotion through continuous re-planning.

Since a promotion is also a method for maximizing the profit of arbitrage, incentives that are provided to customers should be operated not to exceed the profit of arbitrage.

As a method of a promotion, it is possible to transmit information using texts or similar means to customers through the control system of a CPO, and the point in time, etc. may be determined such that information is transmitted through an aggregator system, etc.

Information about a promotion is transmitted through a smartphone application, etc., and information including management of the number of times of participation, the total accumulated capacity/number of times up to the present, etc. can be transmitted to customers having an electric vehicle.

Further, it is possible to provide the location information of a nearby electric vehicle charging station with charged ESSs on the basis of customer location information, whereby it is possible to provide convenience of access to customers.

Further, gifts, cash equivalent resources, etc. may be connected so that differential incentives can be supported in accordance with predetermined number of time and capacity, whereby it is possible to induce active participation of customers.

Further, it is possible to provide differential incentives, as an additional strategy, when the charged amount and the use rate of ESSs at a charging station are low or customers use aged charging stations.

Further, differential incentives can increase a cost value by increasing the use rate of chargers by inducing customers to chargers with a low use rate in consideration of durability, reliability, etc. for the characteristic of chargers having a limited lifespan, and in the case of chargers with a relatively high use rate, it is possible to distribute demands of electric vehicles to be charged by providing low incentives.

As shown in FIG. 1, the plan for charging/discharging an ESS in the demand response market participation step (S10) of the method for electricity market transactions and electric vehicle incentives using an electric vehicle charger-linked electric storage device according to an embodiment of the present disclosure may be characterized by determining the number of electric vehicle to be strategically collected on the day of participation in a DR market in the side of a CPO and establishing an operation strategy on the basis of the number.

When an awarded amount for participating in a DR market is determined, it is required to establish a plan for charging/discharging the ESS according to the awarded market to maximize profits that are gained through the ESS.

The plan for charging/discharging the ESS may be established for each hour, depending on a strategy related to the number of electric vehicles to induce and DR participation time.

In the side of a COP, it may be possible to determine the number of electric vehicles to strategically collect on the corresponding day and establish an operation strategy on the basis of the number.

It is possible to determine the number of electric vehicles to strategically collect on the corresponding day on the basis of the pattern of customers using chargers in each area in the past.

When it is scheduled to participate in a DR market, it is possible to establish a plan for charging or discharging the ESS and determine whether to operate the ESS in accordance with the electricity purchase price and the power consumption by electrical vehicles in the corresponding hour.

As shown in FIG. 1, in the method for electricity market transactions and electric vehicle incentives using an electric vehicle charger-linked electric storage device, the plan for charging/discharging an ESS in the demand response market participation step (S10) may be characterized by satisfying conditions of an objective function,

$$Max . {Cost}_{total} = {Cost}_{DR} + {Cost}_{Arbitrage} ,$$

and a constraint function,

$${Cost}_{DR} = {\sum }_{t = 1}^{24} ( ( {E}_{EV} ( t ) + {E}_{ESS} ( t ) ) \times {Cost}_{DR} ( t ) ) - {Cost}_{Penalty} \\ {Cost}_{Arbitrage} = {\sum }_{t = 1}^{24} ( {E}_{ESS} ( t ) \times {Cost}_{Time} ( t ) ) \\ 0 \leq {E}_{EV} ( t ) + {E}_{ESS} ( t ) \leq Min ( {P}_{Contract} , {P}_{Target} ) \\ If . {E}_{target} ( t ) > ( {E}_{EV} ( t ) + {E}_{ESS} ( t ) ) \\ {Cost}_{Penalty} = {\sum }_{t = 1}^{24} ( ( {E}_{target} ( t ) - ( {E}_{EV} ( t ) + {E}_{ESS} ( t ) ) \times {Cost}_{DR} ( t ) ) \times {Weight}_{Penalty}$$

(where Max.Costₜₒₜₐₗ is a maximum profit (won) using an ESS, Cost_{DR} is a profit (won) through participation in a DR market, Cost_{Arbitrage} is a profit (won) through electricity rate arbitrage, Cost_{Penalty} is a penalty cost (won) due to shortage of DR dynamic response, E_{EV}(t) is a charged amount (kWh) of electric vehicles in each hour, E_{ESS} (t) is charged (+)/discharged (−) amount (kWh) of an ESS in each hour, Cost_{DR} (t) is the amount of awarded price (won/kWh) in a DR market in each hour, Cost_{Time}(t) is an electricity rate (won/kWh) of an EV charging station in each hour, P_{Contract} is a contracted capacity of an EV charging station, F Target is a target peak capacity of an EV charging station, and Weight Penalty is a DR penalty cost weight (p.u)).

As shown in FIG. 1, in the method for electricity market transactions and electric vehicle incentives using an electric vehicle charger-linked electric storage device according to an embodiment of the present disclosure, the objective function of a plan for charging/discharging an ESS may be characterized in that profits are calculated from a profit that is gained by participating in a plus/general DR market and an arbitrage profit that is generated by supplying electricity, which is stored in light load hours through the ESS, in medium load/maximum load hours to maximize a total profit that is obtained through participation in a DR market using the ESS and electric vehicles and electricity rate arbitrage using the ESS.

In this case, the total energy price of the ESS should be changed in accordance with charging hours and costs should be calculated everyday on the basis of prices updated in consideration of the energy price.

Further, since daytime hours with high solar power generation are usually medium load/maximum load hours when participating in a plus DR market, when the ESS is charged to participate in the market, a high charging cost is generated, so this may be calculated as a minus profit.

As shown in FIG. 1, in the method for electricity market transactions and electric vehicle incentives using an electric vehicle charger-linked electric storage device according to an embodiment of the present disclosure, the constraint function of a plan for charging/discharging an ESS may be characterized in that the target number of electric vehicles to be charged and the target charging amount should be values considering the charging times of rapid/slow chargers, the total number of electric vehicles that are charged should not exceed the number of chargers, the charging amounts of electric vehicles and the amount of energy for charging/discharging of the ESS in each hour should be larger than 0 and should be lower than the electricity of the electric vehicle charging station and the target maximum power consumption, and when a penalty cost is generated due to dynamic response not reaching an awarded amount of a DR market, the cost is additionally applied.

As shown in FIG. 1, in the method for electricity market transactions and electric vehicle incentives using an electric vehicle charger-linked electric storage device according to an embodiment of the present disclosure, the promotion operation plan of the ESS discharging step (S40) may be characterized by setting a stage for each hour, setting the intensity of the promotion in each stage, arranging a price for providing the promotion, and establishing a promotion strategy on the basis of them.

As shown in FIG. 1, in the method for electricity market transactions and electric vehicle incentives using an electric vehicle charger-linked electric storage device according to an embodiment of the present disclosure, the promotion operation plan of the ESS discharging step (S40) may be characterized by setting hours pertaining to a preset maximum load in the period of 09:00˜12:00 as first stage hours, setting hours pertaining to a preset maximum load in the period of 13:00˜19:00 as second stage hours, setting hours pertaining to a preset medium load after the second stage hours as third stage hours, establishing a promotion operation plan with relatively low intensity for the first stage hours, and establishing a promotion operation plan with relatively high intensity for the second stage hours and the third stage hours.

FIG. 4 numerically shows the configuration of medium load and maximum load hours of an electric vehicle charge rate plan, in which a medium load hours are indicated by 1 and maximum load hours are indicated by 2. Referring to FIG. 4, it is required to basically induce electric vehicles to visit the charging station and to be charged in the hours of “2” so that the electricity stored in the ESS is completely consumed in order to maximize the profit from the ESS, but when behavior induction is impossible, it is required, as a second plan, to fully consume the stored electricity through an inducing strategy including the hours of “1”.

A promotion strategy is progressed separately for the total of three stages of hours classified as described above, and costs and inducing plans may be determined through the following four steps of procedure.

### Step 1. Setting a Stage for Each Hour

Defining the third stage hours on the basis of the data of FIG. 4, it is possible to define the period in which arbitrage can be maximized as the first stage, and set the first stage hours into 11 h˜12 h in March˜October and 9 h˜12 h in November˜February.

The second stage hours are set into 13 h˜18 h in March˜October and 16 h˜19 h in November˜February.

The third state hours are set into 18 h˜22 h in March˜October and 19 h˜22 h in November˜February.

It is possible to progress a promotion with low intensity in the first stage hours to induce electric vehicles because there is the change of the second stage hours and the third stage hours after the first stage hours.

An intensive promotion should be progressed in earnest in the second stage hours because it is the last period in which the arbitrage can be maximized.

The third state is a period that is progressed when electricity remains in the ESS even in the second stage, and in this stage, a promotion may be progressed with intensity close to that of the second stage.

### Step 2. Defining Promotion Intensity for Each Stage

A period in which maximum arbitrage can be obtained in the first stage hours is exemplified on the basis of summer rates in FIG. 5.

Referring to FIG. 5, when the energy stored in an ESS in light load hours is used in medium load and maximum load hours, the margin of the energy cost is different and the detailed differences in hours are as follows.

For example, as for the electric vehicle charging cost that is sold in 300 won/kWh, the difference between the cost that is supposed to be paid to a power company and the rate obtained from a customer when an electric vehicle is charged in the medium load hours becomes a profit in the side of the CPO, and it is calculated as 157.2 won/kWh, as shown in FIG. 5.

When an ESS is added and an electric vehicle is charged with the electricity stored in the ESS in the medium/maximum load hours, the difference between the charging rate in the light load hours and the cost for charging the electric vehicle becomes the total profit, and it is calculated as 223.5 won/kWh, as shown in FIG. 5.

That is, an equation for calculating the margin of an energy cost can be defined as follows by the ESS and the result becomes the same as the value of energy arbitrage of the ESS.

ESS_arb=ESS_mar−CPO_mar

### Step 3. Arranging Promotion Prices

A promotion for inducing electric vehicle customers using the energy stored in an ESS is a method of inducing customers by arranging variable prices using the profit of a CPO and the profit from an ESS.

The profit of a CPO generated by inducing vehicles means the margin obtained by subtracting the price that is supposed to be paid to a power company in a corresponding hour from the charging rate of the owners of electric vehicles.

The gain in the side of the ESS in discharging in each hour is the amount of money of arbitrage in medium and maximum load hours from the energy cost used for charging in light load hours, and the total gain of the CPO and the ESS is the sum of two values.

Referring to FIG. 6, the profits in respective hours generated by inducing vehicles and the rates for discharging in respective hours in the side of the ESS go to the same amounts of moneys in all of the hours, whereby variables for a profit rates in the hours are removed and the total gain of the CPO+ESS is fixed as a constant.

A total gain from a price policy of a CPO may be shown as in FIG. 7.

It can be seen from the calculation in FIG. 7 that when a CPO individually progresses a promotion, the CPO may suffer a loss at 150 won or less in the promotion in the medium load hours, but when the ESS is operated together, there is no loss even through the promotion is progressed at 70 won or more.

As a result, the value of the ESS is that it is possible to establish a strategy that can set a widest price policy for a promotion, whereby it is possible to continuously gain profits.

However, the first target of a promotion should be operating the promotion in a period in which a profit is secured before an ESS is applied.

That is, it is recommended to not use a promotion in light load hours, it is recommended to raise a CPO rate by 240 won or more in medium load hours, and it is recommended to raise a CPO rate by 200 won or more in maximum load hours.

### Step 4. Establishing a Promotion Strategy

The total profit of COP+ESS that can be seen from the step 2 is used as an important factor when establishing a strategy, and it is possible to establish a strategy in linkage with the strategies for respective stages defined in the step 1.

It is possible to establish a promotion strategy in consideration of the following matters in accordance with the profit distribution ratio of a CPO and an ESS.

As a strategy for the first state hours, the profit in the side of the ESS in discharging in hours should be the same or high when the profit is distributed in accordance with a defined ratio.

For example, the range of a promotion price in the first stage hours may be set to be 0 won<promotion price≤profit in the side of ESS in medium load hours (66. 3 won, see FIG. 6).

As a strategy for the second stage hours, it is possible to strategically arrange prices lower than the first stage.

For example, the range of a promotion price in the second stage hours may be set to be profit in the side of ESS in medium load hours (66. 3 won, see FIG. 6)≤profit in the side of ESS in maximum load hours (107.6 won, see FIG. 6).

As a promotion strategy for the third stage hours, it is a period in which an aggressive policy is required because the energy of an ESS should be maximally discharged as the last step of a promotion.

For example, the range of a promotion price in the third stage hours may be set to be promotion price in the second stage hours<profit in the side of ESS in maximum load hours (107.6 won, see FIG. 6).

An embodiment according to a promotion profit distribution ratio may be shown as in FIG. 8.

In FIG. 8, the periods included in a profit range in medium load hours in the side of an ESS are indicated by solid arrows and the periods included in a profit range in maximum load hours are indicated by dotted arrows.

Assuming that 30% of the total profit is the profit of a CPO, in the period included in a profit in the side of the ESS, the promotion range in the medium load hours should be 180 won or more (maximum 120 won can be reduced for EV charging customers) and the promotion range in the maximum load hours should be 240 won or more (maximum 60 won can be reduced for EV charging customers).

The promotion in the first stage hours can be progressed with low intensity because there is the change of the second stage hours and the third stage hours, and this period corresponds to the maximum load hours, in which the promotion can be progressed at a price less than 60 won.

For example, the promotion can be progressed with reduction of 20 won (280 won/kWh).

Since the promotion in the second stage hours corresponds to the maximum load hours, the promotion may be progressed intensively more than the promotion in the first stage hours and may be mainly progressed close to the end rather than throughout the entire 5 hours to maximize a profit in the side of the CPO.

For example, it is possible to give a notice in advance to customers in 17 h and 18 h and progress a promotion through a reservation system and it is possible to progress the promotion with reduction of maximum 60 won (240 won/kWh).

The promotion for the third stage hours is performed when there is a remaining capacity even after even the promotion in the second stage hours has been progressed, in which the range of a price policy can be widely used.

For example, the intensity may be gradually decreased and reduction of maximum 120 won (180 won/kWh) may be applied in terms of customer marketing.

In order to maximize a profit, it is possible to plan the number of vehicles to induce for charging in hours on the basis of electric vehicles and remaining energy of an ESS on the D-1 day, and when charging amount of electric vehicles is less than the charging amount of electric vehicles expected in the plan on the D-day, it may be possible to perform the promotion plan of D+hour.

Referring to FIG. 9 to describe an embodiment of the method for electricity market transactions and electric vehicle incentives using an electric vehicle charger-linked electric storage device, the term “TOU” (Time Of Use) is an example of rates of contracted types (rates in seasons/hours) that are assigned to chargers in hours.

The term “Arbitrage” in FIG. 9 is a profit that is generated as the difference from the TOU rate in a corresponding hour when an ESS is discharged after the ESS is charged at 74 won that is the rate in the light load hours, and when this profit is used to charge electricity in a corresponding hour, the profit may be considered as a gain by the corresponding rate.

The term “EV charging” in FIG. 9, which is the number of electric vehicles calculated to find out the number of charged electric vehicles in hours, means the number of electric vehicles to be induced in order to achieve the maximum profit by optimizing the total number of electric vehicle in the hours.

In the example of FIG. 9, the charging amount in each hour was calculated under the consideration that electric vehicles to be charged, of which the number acts as a variable, are charged through a slow charger of 7 kW.

The term “ESS charging” in FIG. 9 was additionally applied because it is possible to maximize a profit when participating in a plus DR market and charging an ESS together with charging of electric vehicles.

The term “ESS discharging” in FIG. 9 excluded 12:00˜14:00 for which it participates in a plus DR market and was calculated under the assumption that when there is an electric vehicle, the capacity for charging the electric vehicle is provided from an ESS.

The term “charging/discharging profit” in FIG. 9 is calculated when an ESS is operated as the unit price of arbitrage in each hour.

The term “+DR” in FIG. 9 is a plus DR profit calculated as a product of the total unit price in the market and a capacity in a corresponding hour.

The term “charging cost” is a total cost for charging an ESS when participating in plus DR.

FIG. 9 is the result of an example when the present disclosure is applied, and from which it is possible to see the total number of electric vehicle to be induced in each hour, which is calculated to fit to the maximum profit through an ESS of a capacity of 50 kWh/150 kWh considered in the example.

As shown in FIG. 1, in the method for electricity market transactions and electric vehicle incentives using an electric vehicle charger-linked electric storage device, a price for providing a promotion included in the promotion operation plan of the ESS discharging step (S40) may be calculated from the following equation,

$${Cost}_{PR} ( t ) = ( {Cost}_{kWh} ( t ) - {Cost}_{CHA} ) \times {Ratio}_{B 2 B} \times {Ratio}_{B 2 C} \times {E}_{CHA} ( t )$$

(where Cost_{PR} (t) is the price (won) for providing a promotion in a corresponding hour, Cost_{kWh}(t) is an electricity rate (won/kWh) under KEPCO in a corresponding hour, Cost_{CHA} is an electricity rate (won/kWh) used for charging an ESS under KEPCO, Ratio_{B2B} is a profit distribution ratio (p.u) between a demand manager and a CPO, Ratio_{B2C} is a profit distribution ratio (p.u) between a COP and an owner of an electric vehicle including an incentive, and E_{CHA} (t) is the amount of electricity (kWh) used to charge electric vehicles in a corresponding hour).

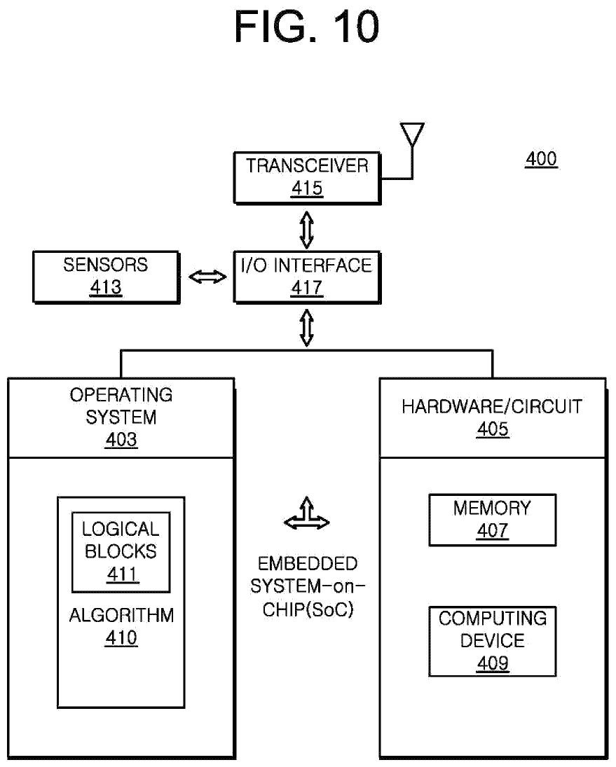

FIG. 10 is a system block diagram of a computing device suitable for use with the method for electricity market transactions and electric vehicle incentives using an electric vehicle charger-linked electric storage device.

The various aspects may be implemented within a variety of computing devices 400, an example of which is illustrated in FIG. 10. In an exemplary embodiment, a computing device 400 may include an operating system 403. The operating system 403 may be a high-level operating system used to manage and execute various logical blocks or algorithms 410 on the computing device 401. The operating system 403 may also enable various logical blocks or algorithms 410 to access hardware/circuit 405, such as memory 407 and a computing device 409.

The computing device may be an embedded processor which is a microprocessor that is used in an embedded system. These processors are usually smaller, use a surface mount form factor and consume less power by using the method for electricity market transactions and electric vehicle incentives using an electric vehicle charger-linked electric storage device. Embedded processors can be divided into two categories: ordinary microprocessors and microcontrollers. Microcontrollers have more peripherals on the chip. Properties typical of embedded computing device when compared with general-purpose ones are e.g. low power consumption, small size, rugged operating ranges and low per-unit cost that can be achieved by utilizing the method for electricity market transactions and electric vehicle incentives using an electric vehicle charger-linked electric storage device.

In another aspect, the operating system 403 may host logical blocks 411. The logical blocks 411 may be one or more software programs that transforms source code written in one programming language (i.e., the source language) into another programming language (i.e., the target language). For example, the source code may be a collection of instructions for the computing devices 409 typically written using a human-readable programming language, such as Java®, C++, Perl®, Python®, etc., and the logical blocks 411 may transform the source code into an executable program. In another aspect, the source code may be in the form of bytecode (i.e., code typically compiled by dynamic compilers and usable on various different platforms). The source code may exist as one or more files or in a database and may be stored on various types of storage media (not shown), such as optical disks or hard-drive disks.

The various illustrative logical blocks 411, modules, circuits, and algorithm steps 410 described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware/circuit 405 used to implement the various method for electricity market transactions and electric vehicle incentives using an electric vehicle charger-linked electric storage device described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose computing device 409 may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium (i.e., stored processor-executable software instructions). The steps of a method or algorithm disclosed herein may be embodied in a processor-executable software module and may be performed as processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The computing device 409, including the method for electricity market transactions and electric vehicle incentives using an electric vehicle charger-linked electric storage device as illustrated in FIGS. 1 to 9, can be implemented in any one or all of personal computers, servers, desktop computers, cellular telephones, smartphones, personal or mobile multi-media players, personal data assistants (PDA's), laptop computers, tablet computers, smartbooks, palm-top computers, wireless electronic mail receivers, multimedia Internet enabled cellular telephones, wireless gaming controllers, IoT (Internet of Things) devices, and similar electronic devices that include a programmable processor and a memory. While the various aspects are particularly useful in mobile computing devices, such as cellular telephones, which have limited processing power and battery capacity, the aspects are generally useful in any computing device that may benefit from reduced compile times and reduced energy consumption.

For example, IoT devices may include many types of sensors 413, each of which is an information source, and different types of sensors 413 capture different content and format of information. Data obtained by the sensor 413 is real-time and the sensor collects the environment information at a certain frequency and keeps updating the data. Additionally, the system block 400 may have one or more transceivers 415 for sending and receiving electromagnetic radiation that may be connected to a wireless data link and/or cellular transceiver 415 coupled to the computing device 409 via I/O interface 417.

A method for electricity market transactions and electric vehicle incentives using an electric vehicle charger-linked electric storage device according to an embodiment of the present disclosure was described above, but it is also possible to implement a computer-readable recording medium storing a program for implementing the method for electricity market transactions and electric vehicle incentives using an electric vehicle charger-linked electric storage device, and a program stored in a computer-readable recording medium for implementing the method for electricity market transactions and electric vehicle incentives using an electric vehicle charger-linked electric storage device.

That is, those skilled in the art can easily understand that the method for electricity market transactions and electric vehicle incentives using an electric vehicle charger-linked electric storage device described above may be included in a computer-readable recording medium by materially implementing a program of commands for implementing the method. In other words, the method according to an embodiment may be implemented in a program that can be executed by various computers and may be recorded on computer-readable recording media. The computer-readable recording media may include program commands, data files, and data structures individually or in combinations thereof. The program commands that are recorded on the computer-readable recording media may be those specifically designed and configured for the present disclosure or may be those available and known to those engaged in computer software in the art. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, flash memory, and USB memory. The program commands include not only machine language codes compiled by a compiler, but also high-level language code that can be executed by a computer using an interpreter etc. The hardware device may be configured to operate as one or more software modules to perform the operation of the present disclosure, and vice versa.

The present disclosure is not limited to the embodiments described above, may be used for various fields, and may be modified in various ways without departing from the spirit of the present disclosure described in claims.

What is claimed is:

1. A method for electricity market transactions and electric vehicle incentives using an electric vehicle charger-linked electric storage device, the method being implemented in a program type that is executed by a computing device including a computer and using an energy storage system (ESS) linked to an electric vehicle charging system, the method comprising:
a demand response market participation step in which the computing device progresses operation of charging and discharging the ESS by establishing a strategy related to the number of electric vehicles to induce and a plan for charging and discharging the ESS in each hour in accordance with a DR (demand response) market participation time when the ESS participates in an electricity demand management market (electricity market);
an ESS charging step in which the computing device charges the ESS in preset light load hours when the ESS does not participate in the electricity demand management market (electricity market);
a system standby step in which the computing device stands by until a predetermined discharging time when the ESS finishes being charged; and
an ESS discharging step in which the computing device establishes a discharging plan to completely discharge energy stored in the ESS during the discharging time, establishes a promotion operation plan, and progresses the promotion in accordance with the promotion operation plan.

2. The method of claim 1, wherein the plan for charging and discharging the ESS in the demand response market participation step determines the number of electric vehicle to strategically collect in a day when participating in the DR market in the side of a charge point operator and establishes an operation strategy on the basis of the number.

3. The method of claim 1, wherein the plan for charging/discharging the ESS in the demand response market participation step satisfies conditions of an objective function,
$$Max . {Cost}_{total} = {Cost}_{DR} + {Cost}_{Arbitrage} ,$$
and a constraint function,
$${Cost}_{DRD} = {\sum }_{t = 1}^{24} ( ( {E}_{EV} ( t ) + {E}_{ESS} ( t ) ) \times {Cost}_{DR} ( t ) ) - {Cost}_{Penalty} \\ {Cost}_{Arbitrage} = {\sum }_{t = 1}^{24} ( {E}_{ESS} ( t ) \times {Cost}_{Time} ( t ) ) \\ 0 \leq {E}_{EV} ( t ) + {E}_{ESS} ( t ) \leq Min ( {P}_{Contract} , {P}_{Target} ) \\ If . {E}_{target} ( t ) > ( {E}_{EV} ( t ) + {E}_{ESS} ( t ) ) \\ {Cost}_{Penalty} = {\sum }_{t = 1}^{24} ( ( {E}_{target} ( t ) - ( {E}_{EV} ( t ) + {E}_{ESS} ( t ) ) \times {Cost}_{DR} ( t ) ) \times {Weight}_{Penalty}$$
(where Max.Costₜₒₜₐₗ is a maximum profit (won) using an ESS, Cost_{DR} is a profit (won) through participation in a DR market, Cost_{Arbitrage} is a profit (won) through arbitrage of an electricity rate, Cost penalty is a penalty cost (won) due to shortage of DR dynamic response, E_{EV}(t) is a charged amount (kwh) of electric vehicles in each hour, E_{ESS}(t) is charged (+)/discharged (−) amount (kWh) of an ESS in each hour, Cost_{DR}(t) is the amount of awarded price (won/kwh) in a DR market in each hour, Cos_{Time}(t) is an electricity rate (won/kWh) of an EV charging station in each hour, P_{Contract} is a contracted capacity of an EV charging station, P_{Target} is a target peak capacity of an EV charging station, and Weight_{Penalty} is a DR penalty cost weight (p.u).

4. The method of claim 3, wherein the objective function of the plan for charging/discharging the ESS calculates profits from a profit that is gained by participating in a plus/general DR market and an arbitrage profit that is generated by supplying electricity, which is stored in light load hours through the ESS, in medium load/maximum load hours to maximize a total profit that is obtained through participation in the DR market using the ESS and electric vehicles and electricity rate arbitrage using the ESS.

5. The method of claim 3, wherein in the constraint function of a plan for charging/discharging an ESS, a target number of electric vehicles to be charged and a target charging amount should be values considering charging times of rapid/slow chargers, a total number of electric vehicles that are charged per hour should not exceed the number of chargers, charging amounts of electric vehicles and the amount of energy for charging and discharging of the ESS in each hour should be larger than 0 and should be lower than electricity of an electric vehicle charging station and target maximum power consumption, and when a penalty cost is generated due to dynamic response not reaching an awarded amount of the DR market, the cost is additionally applied.

6. The method of claim 1, wherein the promotion operation plan of the ESS discharging step is to set a stage for each hour, set intensity of the promotion in each stage, sets a price for providing the promotion, and establish a promotion strategy on the basis of the stage, the intensity, and the price.

7. The method of claim 6, wherein the promotion operation plan of the ESS discharging step is to set hours pertaining to a preset maximum load in a period of 09:00˜12:00 as first stage hours, set hours pertaining to a preset maximum load in a period of 13:00˜19:00 as second stage hours, set hours pertaining to a preset medium load after the second stage hours as third stage hours, establish the promotion operation plan with relatively low intensity for the first stage hours, and establish the promotion operation plan with relatively high intensity for the second stage hours and the third step hours.

8. The method of claim 6, wherein a price for providing a promotion included in the promotion operation plan of the ESS discharging step is calculated from the following equation,
$${Cost}_{PR} ( t ) = ( {Cost}_{kWh} ( t ) - {Cost}_{CHA} ) \times {Ratio}_{B 2 B} \times {Ratio}_{B 2 C} \times {E}_{CHA} ( t )$$
(where Cost_{kWh}(t) is the price (won) for providing a promotion in a corresponding hour, Cost_{CHA} is an electricity rate (won/kWh) under KEPCO in a corresponding hour, Ratio_{B2B} is an electricity rate (won/kWh) used for charging an ESS under KEPCO, Ratio_{B2C} is a profit distribution ratio (p.u) between a demand manager and a CPO, E_{CHA}(t) is a profit distribution ratio (p.u) between a COP and an owner of an electric vehicle including an incentive, and Cost_{kWh}(t) is the amount of electricity (kWh) used to charge electric vehicles in a corresponding hour).

9. A computer-readable recording medium storing a program for implementing the method for electricity market transactions and electric vehicle incentives using an electric vehicle charger-linked electric storage device of claim 1.

10. A program stored in a computer-readable recording medium for implementing the method for electricity market transactions and electric vehicle incentives using an electric vehicle charger-linked electric storage device of claim 1.
